(19) United States
(12) Patent Application Publication
(10) Pub. No.: US 2026/0280763 A1
(43) Pub. Date: Sep. 17, 2026

(54) DYNAMIC BLOCK INTERLEAVER SELECTION

(71) Applicant: QUALCOMM Incorporated, San Diego, CA (US)

(72) Inventors: Somsubhra BARIK, San Diego, CA (US); Jing SUN, San Diego, CA (US)

(21) Appl. No.: 19/080,008

(22) Filed: Mar. 14, 2025

(51) Int. Cl. H04L 1/00; H04L 5/00; H04W 72/0446; H04W 72/0453

(52) U.S. Cl. CPC H04L 1/0071; H04L 5/0048; H04W 72/0446; H04W 72/0453

(57) ABSTRACT

Various aspects of the present disclosure generally relate to wireless communication. In some aspects, a user equipment (UE) may receive an indication of a dynamic block interleaver selection from a finite set of candidate block interleavers for a virtual resource block to physical resource block mapping in a frequency domain. The UE may perform a communication based at least in part on the dynamic block interleaver selection. Numerous other aspects are described.

### FIELD OF THE DISCLOSURE

Aspects of the present disclosure generally relate to wireless communication, and specifically relate to techniques, apparatuses, and methods associated with dynamic block interleaver selection.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

The systems, methods, and devices of this disclosure each have several innovative aspects, no single one of which is solely responsible for the desirable attributes disclosed herein.

In some implementations, a method of wireless communication performed by a user equipment (UE) includes receiving an indication of a dynamic block interleaver selection from a finite set of candidate block interleavers for a virtual resource block (VRB) to physical resource block (PRB) (VRB-to-PRB) mapping in a frequency domain; and performing a communication based at least in part on the dynamic block interleaver selection.

In some implementations, a method of wireless communication performed by a network node includes transmitting an indication of a dynamic block interleaver selection from a finite set of candidate block interleavers for a VRB-to-PRB mapping in a frequency domain; and performing a communication based at least in part on the dynamic block interleaver selection.

In some implementations, an apparatus for wireless communication at a UE includes one or more memories; and one or more processors, coupled to the one or more memories, configured to cause the UE to: receive an indication of a dynamic block interleaver selection from a finite set of candidate block interleavers for a VRB-to-PRB mapping in a frequency domain; and perform a communication based at least in part on the dynamic block interleaver selection.

In some implementations, an apparatus for wireless communication at a network node includes one or more memories; and one or more processors, coupled to the one or more memories, configured to cause the network node to: transmit an indication of a dynamic block interleaver selection from a finite set of candidate block interleavers for a VRB-to-PRB mapping in a frequency domain; and perform a communication based at least in part on the dynamic block interleaver selection.

In some implementations, a non-transitory computer-readable medium storing a set of instructions for wireless communication includes one or more instructions that, when executed by one or more processors of a UE, cause the UE to: receive an indication of a dynamic block interleaver selection from a finite set of candidate block interleavers for a VRB-to-PRB mapping in a frequency domain; and perform a communication based at least in part on the dynamic block interleaver selection.

In some implementations, a non-transitory computer-readable medium storing a set of instructions for wireless communication includes one or more instructions that, when executed by one or more processors of a network node, cause the network node to: transmit an indication of a dynamic block interleaver selection from a finite set of candidate block interleavers for a VRB-to-PRB mapping in a frequency domain; and perform a communication based at least in part on the dynamic block interleaver selection.

In some implementations, an apparatus for wireless communication includes means for receiving an indication of a dynamic block interleaver selection from a finite set of candidate block interleavers for a VRB-to-PRB mapping in a frequency domain; and means for performing a communication based at least in part on the dynamic block interleaver selection.

In some implementations, an apparatus for wireless communication includes means for transmitting an indication of a dynamic block interleaver selection from a finite set of candidate block interleavers for a VRB-to-PRB mapping in a frequency domain; and means for performing a communication based at least in part on the dynamic block interleaver selection.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless network.

FIG. 2 is a diagram illustrating an example disaggregated base station architecture.

FIG. 3 is a diagram illustrating an example of a block interleaver.

FIG. 4 is a diagram illustrating an example associated with dynamic block interleaver selection.

FIG. 5 is a flowchart illustrating an example process performed, for example, by a UE.

FIG. 6 is a flowchart illustrating an example process performed, for example, by a network node.

FIGS. 7-8 are diagrams of example apparatuses for wireless communication.

### DETAILED DESCRIPTION

A transmitter may use a block interleaver to rearrange a set of symbols without omitting or repeating any symbols in the set of symbols. A number of symbols in the set of symbols may be fixed for a given block interleaver. The block interleaver may load resource block bundles (RBBs) column-by-column (e.g., write in column). A loading of the RBBs may correspond to a writing into the block interleaver The transmitter may transmit the RBBs row-by-row (e.g., reading from the block interleaver) until the block interleaver is empty. The block interleaver may then be reloaded with additional RBBs and a cycle may be repeated. At a receiver, the RBBs may be de-interleaved prior to a decoding of the RBBs. The block interleaver may serve to improve a transmission efficiency and reduce a bit error rate over fading channels.

The block interleaver may be associated with an interleaver matrix. The interleaver matrix may be defined by R rows and C columns. Each entry of the interleaver matrix may correspond to an interleaving unit, which may be an RBB. An RBB size L may determine a resolution of an interleaving in a frequency domain. A physical RBB may be indexed from 0, 1, . . . , N_{bundle}-1, where N_{bundle} is a number of RBBs in an allocation per symbol. A size of an RBB, L, may be provided by a higher layer parameter. A transmitter may determine a set of physical RBBs with one or more resource blocks allocated to each RBB. Virtual RBBs may be mapped to physical RBBs using a block interleaver with R rows and C columns.

A virtual resource block to physical resource block (VRB-to-PRB) interleaving in a frequency domain may be specified in terms of the block interleaver with an interleaver depth of

$$⌊ \frac{{N}_{RBB}}{2} ⌋$$

and an RDD SIZE (L) of 2 or 4 RBs, where N_{RBB} is a number of RBBs. In some aspects, the output of the interleaver may be interpreted as the VRB indices, the R rows in the block interleaver matrix may correspond to the interleaving depth or a number of non-contiguous clusters across which adjacent RBBs are spread upon interleaving and the C columns in the block interleaver matrix may correspond to a size of each cluster in RBBs (e.g., a frequency domain separation of the clusters). In some aspects, the output of the interleaver may be interpreted as the PRB indices, the C columns in the block interleaver matrix may correspond to the interleaving depth or a number of non-contiguous clusters across which adjacent RBBs are spread upon interleaving, and the R rows in the block interleaver matrix may correspond to a size of each cluster in RBBs (e.g., a frequency domain separation of the clusters).

The VRB-to-PRB interleaving may lead to a performance loss for a channel that exhibits some degree of periodicity in its frequency response. An example of a periodic channel may be a tapped delay line (TDL) channel at a low-scattering environment. The periodic channel may include a massive MIMO network node setup with a near-perfect beamforming at a transmitter side that prunes all but the top two paths of an effective channel. The VRB-to-PRB interleaving may be based at least in part on a deterministic block interleaver, where the deterministic block interleaver may be relatively non-complex to implement at a UE, and the deterministic block interleaver may avoid signaling additional information for interleaving and/or deinterleaving operations. For example, a generic random interleaver may involve transmitting additional signaling to share a random mapping or a pseudo-random seed generator with a receiver.

The deterministic block interleaver may not be specific to a selection of the interleaver depth. A rectangular block interleaver (e.g., any rectangular block interleaver) with an arbitrary interleaver depth may have some performance loss when a channel periodicity (e.g., separation between consecutive peaks of channel frequency response) coincides with an interleaver span (e.g., separation of the clusters) in the frequency domain. A throughput performance may experience significant dips depending on a tap separation in the periodic channel. When the deterministic block interleaver is used (e.g., when the block interleaver with the arbitrary interleaver depth is used), the performance loss may occur when the channel periodicity coincides with the interleaver span in the frequency domain, which may degrade an overall system performance. Depending on an implementation of an interleaver, a separation of clusters may be either rows or columns.

Various aspects relate generally to block interleavers. Some aspects more specifically relate to dynamic block interleaver selection. A block interleaver selection may be dynamic since a block interleaver may not be necessarily fixed for an entire duration of a transmission and the block interleaver may vary depending on channel conditions. The block interleaver selection may be based at least in part on downlink control information (DCI), radio resource control (RRC) signaling, or a medium access control (MAC) control element (MAC-CE). Block interleaver selections may be semi-static or may vary slot-by-slot. In some examples, a VRB-to-PRB interleaver channel adaptation may be employed, which may involve a dynamic block interleaver switching. A dynamic or adaptive block interleaver may be used in a frequency domain to avoid a given code block experiencing periodic throughput dips in a periodic channel. The periodic channel may be a channel that exhibits some degree of periodicity in its frequency response. A dynamic switching of an interleaver configuration may be based at least in part on a detected channel periodicity in the periodic channel. The dynamic switching may involve using multiple block interleavers having different interleaving depths, at separate times, to allow for the periodic throughput dips in the periodic channel to be avoided.

Particular aspects of the subject matter described in this disclosure can be implemented to realize one or more of the following potential advantages. In some examples, by dynamically switching between multiple candidate block interleaver configurations, the described techniques can be used to avoid performance losses associated with individual block interleavers. The individual block interleavers may be associated with throughput dips when channel taps are separated by respective distances. By using the individual block interleavers together (e.g., by intelligently switching between the individual block interleavers instead of using the same block interleaver an entire time), the throughput dips associated with the individual block interleavers may be avoided, thereby improving an overall system performance.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

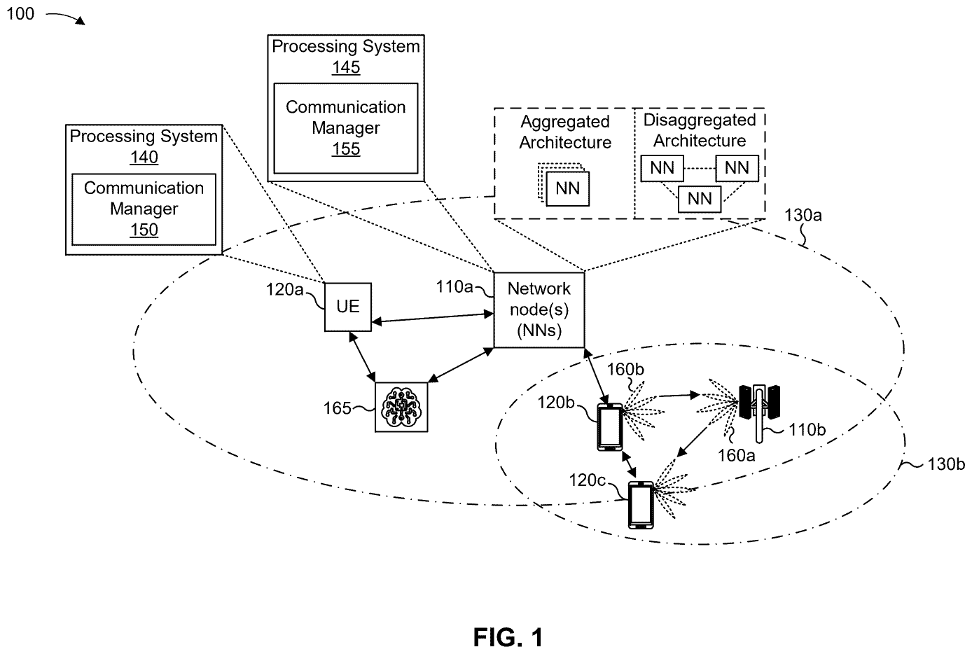

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHZ), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as an RRC layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a DCI configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC-CE, an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, a UE (e.g., the UE 120) may include a communication manager 150. As described in more detail elsewhere herein, the communication manager 150 may receive an indication of a dynamic block interleaver selection from a finite set of candidate block interleavers for a VRB-to-PRB mapping in a frequency domain; and perform a communication based at least in part on the dynamic block interleaver selection. Additionally, or alternatively, the communication manager 150 may perform one or more other operations described herein.

In some aspects, a network node (e.g., the network node 110) may include a communication manager 155. As described in more detail elsewhere herein, the communication manager 155 may transmit an indication of a dynamic block interleaver selection from a finite set of candidate block interleavers for a VRB-to-PRB mapping in a frequency domain; and perform a communication based at least in part on the dynamic block interleaver selection. Additionally, or alternatively, the communication manager 155 may perform one or more other operations described herein.

As indicated above, FIG. 1 is provided as an example. Other examples may differ from what is described with regard to FIG. 1.

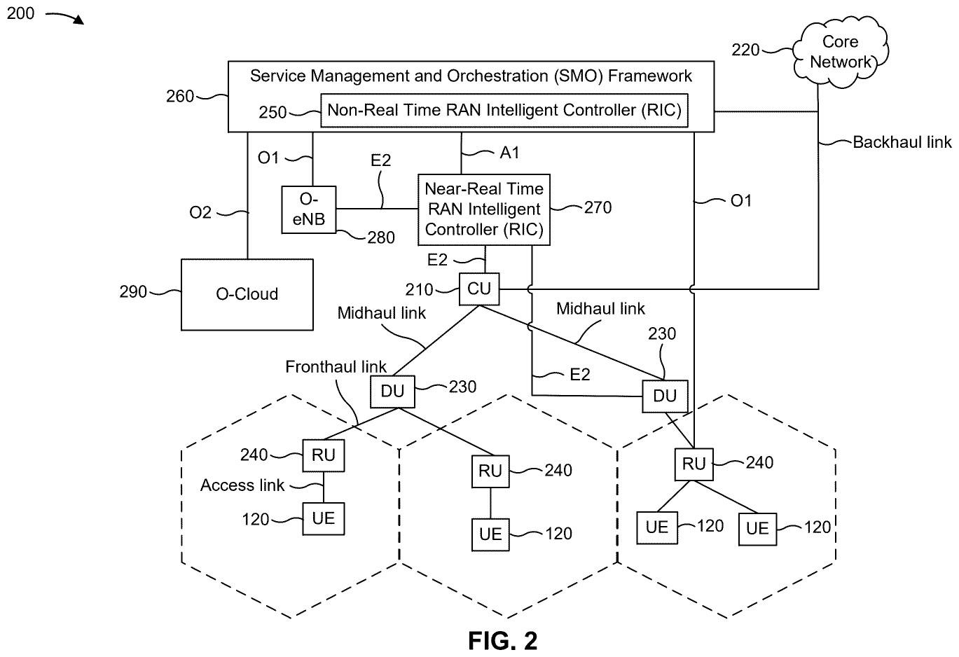

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

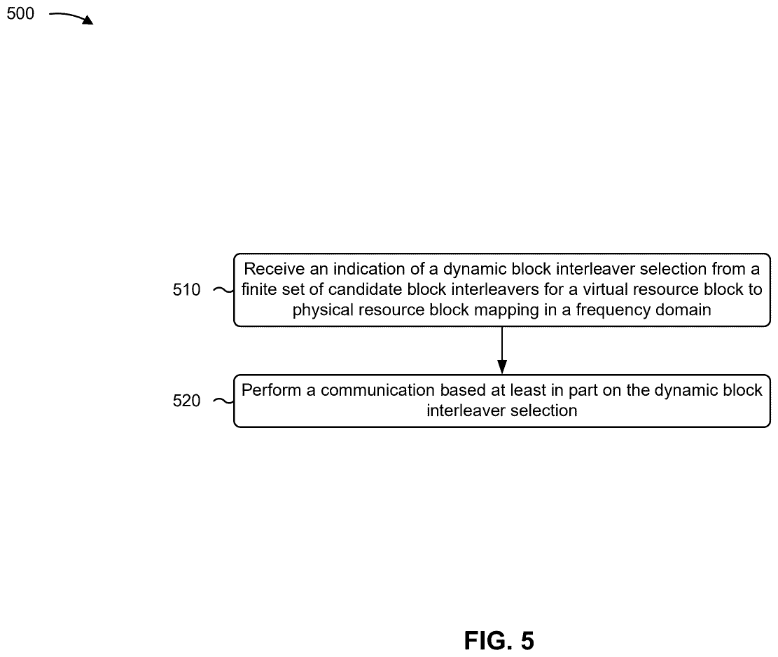

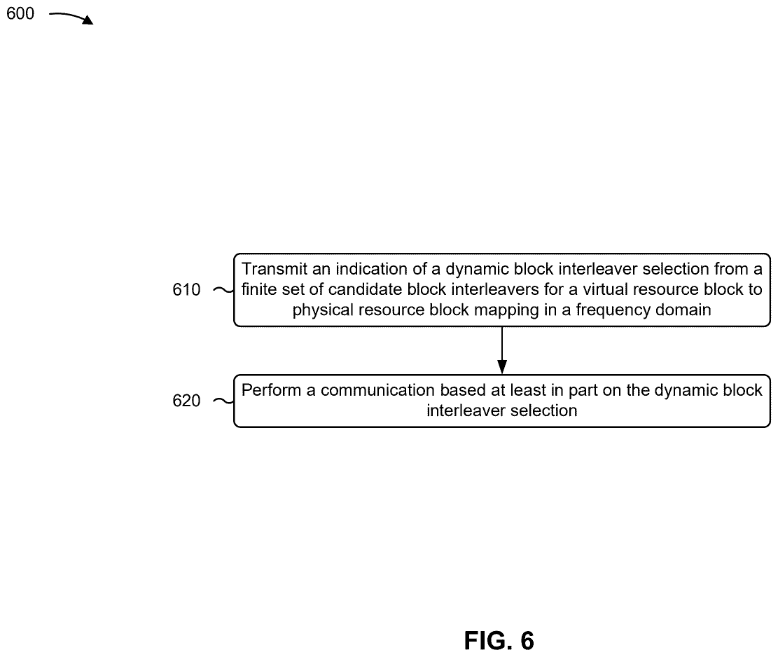

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with dynamic block interleaver selection, as described in more detail elsewhere herein. For example, the processing system 145 of the network node 110, the processing system 140 of the UE 120, the CU 210, the DU 230, or the RU 240 may perform or direct operations of, for example, process 500 of FIG. 5, process 600 of FIG. 6, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 500 of FIG. 5, process 600 of FIG. 6, or other processes as described herein. In some examples, executing instructions may include running the instructions, converting the instructions, compiling the instructions, or interpreting the instructions, among other examples.

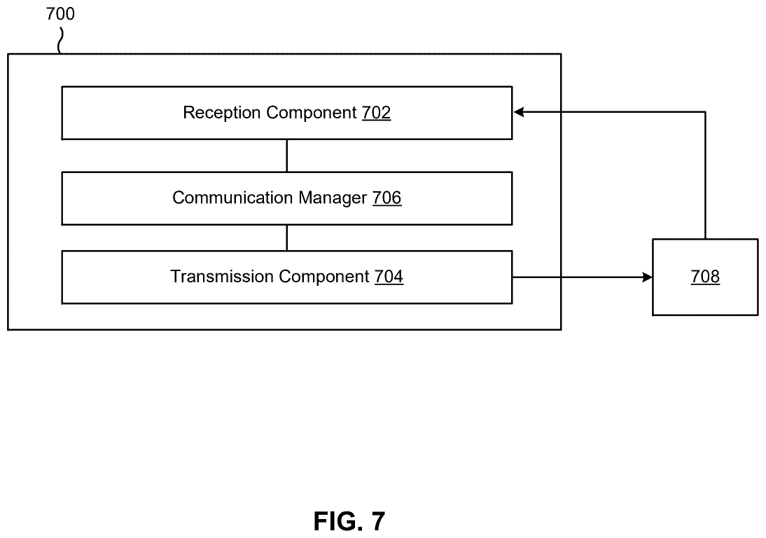

In some aspects, a UE (e.g., the UE 120) includes means for receiving an indication of a dynamic block interleaver selection from a finite set of candidate block interleavers for a VRB-to-PRB mapping in a frequency domain; and/or means for performing a communication based at least in part on the dynamic block interleaver selection. The means for the UE to perform operations described herein may include, for example, one or more of communication manager 150, processing system 140, a radio, one or more RF chains, one or more transceivers, one or more antennas, one or more modems, a reception component (for example, reception component 702 depicted and described in connection with FIG. 7), or a transmission component (for example, transmission component 704 depicted and described in connection with FIG. 7), among other examples.

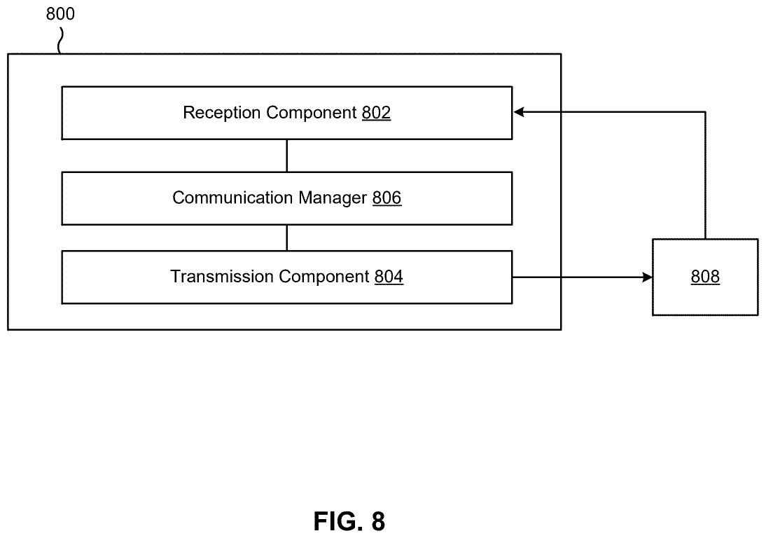

In some aspects, a network node (e.g., the network node 110) includes means for transmitting an indication of a dynamic block interleaver selection from a finite set of candidate block interleavers for a VRB-to-PRB mapping in a frequency domain; and/or means for performing a communication based at least in part on the dynamic block interleaver selection. The means for the network node to perform operations described herein may include, for example, one or more of communication manager 155, processing system 145, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

As indicated above, FIG. 2 is provided as an example. Other examples may differ from what is described with regard to FIG. 2.

As part of a mapping from VRBs to PRBs, a UE may assume that VRBs are mapped to PRBs according to an indicated mapping scheme (e.g., non-interleaved mapping or interleaved mapping). When no mapping scheme is indicated, the UE may assume that the non-interleaved mapping is used.

For a non-interleaved VRB-to-PRB mapping, VRB n may be mapped to PRB n, except for PDSCH transmissions scheduled with DCI format 1_0 in a common search space (CSS), in which case VRB n may be mapped to

$$PRB n + {N}_{s t a r t}^{CORESET} , where {N}_{s t a r t}^{CORESET}$$

is a lowest-numbered PRB in a control resource set where a corresponding DCI was received. When two PDCCH candidates from two linked CSS sets, as indicated by a search space linking (searchSpaceLinking) higher layer parameter, are detected, and the two linked CSS sets are associated with different control resource sets, a control resource set with a lowest number among the two linked control resource sets may be used to determine

$${N}_{s t a r t}^{CORESET} .$$

For an interleaved VRB-to-PRB mapping, a mapping process may be defined. RBBs may be defined as part of the mapping process. For PDSCH transmissions scheduled with a DCI format 1_0 with a cyclic redundancy check (CRC) scrambled by a system information radio network temporary identifier (SI-RNTI) in a Type0-PDCCH common search space in control resource set (CORESET) 0, a set of

$${N}_{B W P , i n i t}^{s i z e}$$

resource blocks in CORESET 0 may be divided into

$${N}_{bundle} = ⌈ {N}_{B W P , i n i t}^{s i z e} / L ⌉ RBBs$$

in increasing order of resource block number and bundle number, where L=2 is a bundle size and

$${N}_{B W P , i n i t}^{s i z e}$$

is a size of CORESET 0.

$${N}_{b u n d l e} - 1 may include {N}_{B W P , i n i t}^{s i z e} mod L$$

resource blocks when

$${N}_{BWP , init}^{size} mod L > 0 ,$$

and L resource blocks otherwise. All other RBBs may include L resource blocks.

For PDSCH transmissions scheduled with a DCI format 1_0 in any CSS in bandwidth part i with a starting position

$${N}_{BWP , i}^{start} ,$$

other than Type0-PDCCH common search space in CORESET 0, a set of

$${N}_{BWP , init}^{size} VRBs \{ 0 , 1 , … , {N}_{BWP , i n i t}^{size} - 1 \} , where {N}_{BWP , init}^{size}$$

is a size of CORESET 0 when CORESET 0 is configured for a cell and a size of an initial downlink BWP when CORESET 0 is not configured for the cell, may be divided into N_{bundle} virtual RBBs in increasing order of virtual resource block number and virtual bundle number, and a set of

$${N}_{BWP , init}^{size} PRBs \{ {N}_{start}^{CORESET} , {N}_{start}^{CORESET} + 1 , … , {N}_{start}^{CORESET} + {N}_{BWP , init}^{size} - 1 \}$$

may be divided into N_{bundle} physical RBBs in increasing order of physical resource block number and physical bundle number, where

$${N}_{bundle} = ⌈ ( {N}_{BWP , init}^{size} + ( {N}_{BWP , i}^{start} + {N}_{start}^{CORESET} ) mod L ) / L ⌉ , L = 2$$

is a bundle size, and

$${N}_{start}^{CORESET}$$

is a lowest-numbered PRB in a control resource set where a corresponding DCI was received. When two PDCCH candidates from two linked search space sets, as indicated by a searchSpaceLinking higher layer parameter, are detected, and the two linked search space sets are associated with different control resource sets, the control resource set with a lowest number among the two linked control resource sets may be used to determine

$${N}_{start}^{CORESET} . RBB 0 may include L - ( ( {N}_{BWP , i}^{start} + {N}_{start}^{CORESET} ) mod L )$$

resource blocks.

$$RBB {N}_{bundle} - 1 may include ( {N}_{BWP , init}^{size} + {N}_{BWP , i}^{start} + {N}_{start}^{CORESET} ) mod L$$

resource blocks when

$$( {N}_{B W P , i n i t}^{s i z e} + {N}_{B WP , i}^{s t a r t} + {N}_{s t a r t}^{CORESET} ) mod L > 0 ,$$

and L resource blocks otherwise. All other RBBs may include L resource blocks.

For all other PDSCH transmissions, a set of

$${N}_{B W P , i}^{s i z e}$$

resource blocks in a BWP i with a starting position

$${N}_{B WP , i}^{s t a r t}$$

may be divided into

$${N}_{b u n d l e} = ⌈ ( {N}_{B W P , i}^{s i z e} + ( {N}_{B WP , i}^{s t a r t} mod {L}_{i} ) ) / {L}_{i} ⌉ RBBs$$

in increasing order of resource block number and bundle number, where Lᵢ is a bundle size for BWP i provided by a VRB-to-PRB interleaver (vrb-ToPRB-Interleaver) higher layer parameter for DCI formats 1_0, 1_1, and 1_3 in a UE-specific search space, or vrb-ToPRB-InterleaverDCI-1-2 for DCI format 1_2. RBB 0 may include

$${L}_{i} - ( {N}_{BWP , i}^{start} mod {L}_{i} ) resource blocks .$$

$$RBB {N}_{bundle} - 1 may include ( {N}_{BWP , i}^{start} + {N}_{BWP , i}^{size} ) mod {L}_{i}$$

resource blocks when

$$( {N}_{B W P , i}^{start} + {N}_{B W P , i}^{s i z e} ) mod {L}_{i} > 0 , and {L}_{i}$$

resource blocks otherwise. All other RBBs may include L; resource blocks.

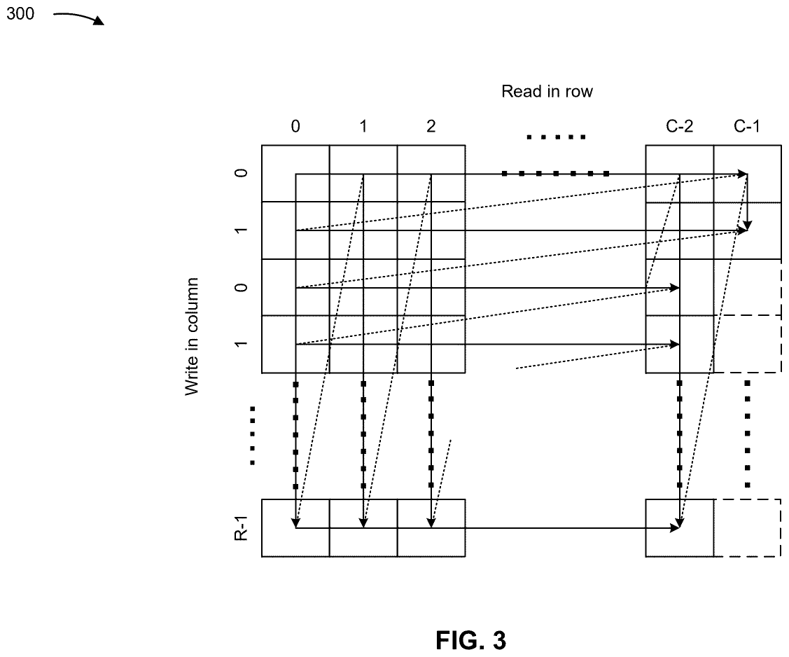

FIG. 3 is a diagram illustrating an example 300 of a block interleaver.

A transmitter may use a block interleaver, such as an NR block interleaver, to rearrange a set of symbols without omitting or repeating any symbols in the set of symbols. A number of symbols in the set of symbols may be fixed for a given block interleaver. The block interleaver may load RBBs row-by-row (e.g., write in column). The transmitter may transmit the RBBs row-by-row until the block interleaver is empty (e.g., read in row). The block interleaver may then be reloaded with additional RBBs and a cycle may be repeated. At a receiver, the RBBs may be de-interleaved prior to a decoding of the RBBs. The block interleaver may serve to improve a transmission efficiency and reduce a bit error rate over fading channels.

As shown in FIG. 3, the block interleaver may be associated with a block interleaver matrix. The block interleaver matrix may be defined by R rows and C columns. Each entry of the block interleaver matrix may correspond to an interleaving unit, which may be an RBB. An RBB size L may determine a resolution of an interleaving in a frequency domain.

As indicated above, FIG. 3 is provided as an example. Other examples may differ from what is described with regard to FIG. 3.

In an NR system, a physical RBB may be indexed from 0, 1, . . . , N_{bundle}−1, where N_{bundle} is a number of RBBs in a UE allocation per symbol. A size of an RBB (RBB bundle size), L, may be provided by a vrb-ToPRB-Interleaver higher layer parameter (e.g., 2 RBs or 4 RBs). A UE may determine a set of physical RBBs with one or more resource blocks allocated to each RBB. Virtual RBBs may be mapped to physical RBBs using a block interleaver, where the block interleaver may be associated with a block interleaver matrix having R rows and C columns. Virtual RB j ∈ {0, 1, . . . , N_{bundle}−2} may be mapped to physical RBB f(j), where: f(j)=rC+c, j=cR+r, r=0, 1, . . . , R−1, c=0, 1, . . . , C−1, f(N_{bundle}−1)=N_{bundle}−1, R=2, and C=└N_{bundle}/R┘ (e.g., floor (N_{bundle}/R)). Further, L may be configured to be greater than or equal to a precoding resource block group (PRG) size, and RBBs may be boundary-aligned with PRGs for narrowband PRB bundling.

A VRB-to-PRB interleaving in a frequency domain may be specified in terms of the block interleaver with an interleaver depth of

$$⌊ \frac{{N}_{R B B}}{2} ⌋$$

and an KBB size (L) of 2 or 4 RBs, where N_{RBB} is a number of RBBs. In some aspects, the R rows in the block interleaver matrix may correspond to the interleaving depth or a number of non-contiguous clusters across which adjacent RBBs are spread upon interleaving and the C columns in the block interleaver matrix may correspond to a size of each cluster in RBBs (e.g., a frequency domain separation of the clusters). In some aspects, the C columns in the block interleaver matrix may correspond to the interleaving depth or a number of non-contiguous clusters across which adjacent RBBs are spread upon interleaving and the R rows in the block interleaver matrix may correspond to a size of each cluster in RBBs (e.g., a frequency domain separation of the clusters).

The VRB-to-PRB interleaving may lead to a performance loss for a channel that exhibits some degree of periodicity in its frequency response. An example of a periodic channel may be a TDL channel at a low-scattering environment. In some aspect, the periodic channel may include a massive MIMO network node setup with a near-perfect beamforming at a transmitter side that prunes all but the top two paths of a channel. The VRB-to-PRB interleaving may be based at least in part on a deterministic block interleaver, where the deterministic block interleaver may be relatively non-complex to implement at a UE, and the deterministic block interleaver may avoid signaling additional information for interleaving and/or deinterleaving operations. For example, a generic random interleaver may involve transmitting additional signaling to share a random mapping or a pseudo-random seed generator with a receiver.

The deterministic block interleaver may not be specific to a selection of the interleaver depth. A rectangular block interleaver (e.g., any rectangular block interleaver) with an arbitrary interleaver depth may have some performance loss when a channel periodicity coincides with an interleaver span in a frequency domain. As an example, 46 RBBs, with 4 RBs each, may be interleaved in the frequency domain using a 5 by 10 block interleaver. The interleaver span in the frequency domain may be approximately 13 MHz, which may correspond to a time domain separation of approximately 77 nanoseconds (ns). The time domain separation may correspond to an inter-tap distance. A throughput performance may degrade when a tap separation of an underlying two-tap channel is an integer multiple of approximately 77 ns. In other words, a throughput loss may result at multiples of approximately 77 ns. The separation of approximately 77 ns may be between two taps of the two-tap channel. In this example, when the deterministic block interleaver is used (e.g., when the block interleaver with the arbitrary interleaver depth is used), the performance loss may occur when the channel periodicity coincides with the interleaver span in the frequency domain, which may degrade an overall system performance.

In various aspects of techniques and apparatuses described herein, a VRB-to-PRB interleaver channel adaptation may be employed, which may involve a dynamic block interleaver switching. A dynamic or adaptive block interleaver may be used in a frequency domain to avoid a given code block experiencing periodic dips in a periodic channel. The periodic channel may be a channel that exhibits some degree of periodicity in its frequency response. A dynamic switching of an interleaver configuration may be based at least in part on a detected channel periodicity in the periodic channel.

As an example, a simulation may involve two candidate block interleaver configurations and a two-tap channel. The two candidate block interleaver configurations may be considered with 272 RBBs (e.g., approximately 400 MHz) and an RBB size of 48 tones. A first candidate block interleaver configuration may define a 17 by 16 block interleaver. The 17 by 16 block interleaver may have an interleaver span that corresponds to a tap separation of approximately 43.4 ns. A second candidate block interleaver configuration may define a 30 by 10 block interleaver. The 30 by 10 block interleaver may have an interleaver span that corresponds to a tap separation of approximately 77.2 ns. For the 30 by 10 block interleaver, a performance may primarily depend on a first 9 columns, because a last column may have only two RBBs, which may effectively reduce the second candidate block interleaver configuration to a 30 by 9 block interleaver. Individual block interleavers may result in throughput dips when channel taps are separated by respective distances. For example, the 17 by 16 block interleaver may produce a throughput dip every approximately 43.4 ns and the 30 by 10 block interleaver may produce a throughput dip every approximately 77.2 ns, which may be based at least in part on channel periodicities.

In some aspects, by intelligently switching between the two candidate block interleaver configurations, a network node may recover a substantial amount of performance loss associated with the individual block interleavers. The intelligent switching between the two candidate block interleaver configurations may result in an envelope block interleaver, which may avoid throughput dips associated with the individual block interleavers. The intelligent switching between the two candidate block interleaver configurations may be effective to reduce performance loss when multiples of respective interleaver spans do not coincide with each other (e.g., 9 and 16 are co-prime to each other). In other words, prior to an anticipated performance loss in a first block interleaver, which may be known based at least in part on a known channel periodicity (e.g., a channel periodicity coincides with an interleaver span in a frequency domain, which causes the anticipated performance loss), a switching from the first block interleaver to a second block interleaver may be employed. Switching to the second block interleaver may avoid the anticipated performance loss associated with the first block interleaver. Prior to an anticipated performance loss in the second block interleaver, a switching from the second block interleaver to the first block interleaver may be employed. Switching back to the first block interleaver may avoid the anticipated performance loss associated with the second block interleaver.

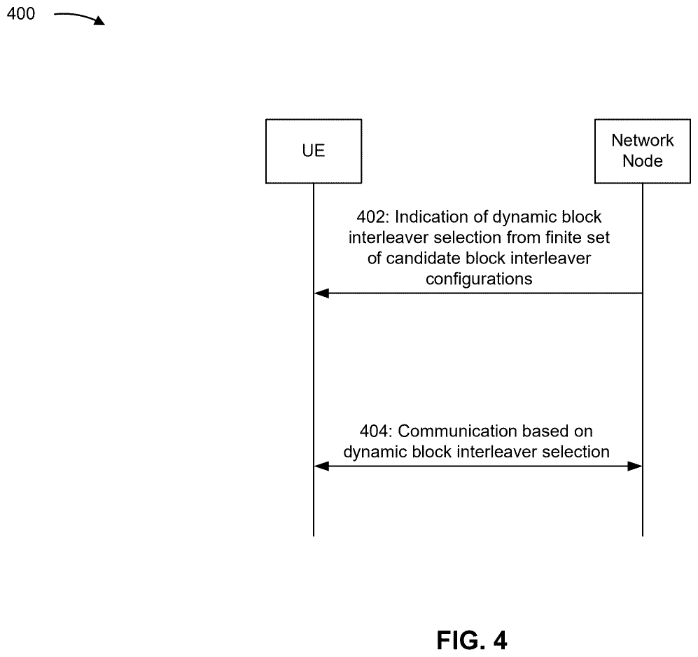

FIG. 4 is a diagram illustrating an example 400 associated with dynamic block interleaver selection, in accordance with the present disclosure. As shown in FIG. 4, example 400 includes communication between a UE (e.g., UE 120) and a network node (e.g., network node 110). In some aspects, the UE and the network node may be included in a wireless network, such as wireless network 100.

As shown by reference number 402, the UE may receive, from the network node, an indication of a dynamic block interleaver selection from a finite set of candidate block interleavers for a VRB-to-PRB mapping in a frequency domain. The finite set of candidate block interleavers may be associated with a respective finite set of candidate block interleaver configurations. The dynamic block interleaver selection may be based at least in part on a separation between taps in an underlying periodic channel. A channel tap may be some modification to a part of a signal. The dynamic block interleaver selection may be based at least in part on an upper limit of a channel tap separation that is permissible. The upper limit of the channel tap separation may define a range of tap domain delay spreads over which a dynamic block interleaving is performed. The upper limit of the channel tap separation may be a predefined value or an RRC configured value based at least in part on a channel history. The finite set of candidate block interleavers may be configured such that a least common multiple of a corresponding set of interleaver spans is greater than the upper limit of the channel tap separation. The upper limit of the channel tap separation may be based at least in part on a cellular inter-side distance (ISD) and/or a frequency band of operation. The dynamic block interleaver selection may be based at least in part on an interleaver span of a current block interleaver and a margin. The margin may be based at least in part on the finite set of block interleavers and the upper limit of the channel tap separation.

In some aspects, the dynamic block interleaver selection may be associated with a dynamic block interleaver switching. The dynamic block interleaver switching may be based at least in part on an estimated channel periodicity using a reference signal. In some aspects, the estimated channel periodicity may be based at least in part on a UE-assisted estimation using an SSB, a CSI-RS, a TRS, or a DMRS. The UE may transmit, to the network node based at least in part on the UE-assisted estimation, feedback that indicates a preferred dynamic block interleaver or an estimated delay bin. The indication of the preferred dynamic block interleaver may be based at least in part on the feedback. In some aspects, the estimated channel periodicity may be based at least in part on a network node assisted estimation. The network node assisted estimation may be based at least in part on an uplink SRS and a channel reciprocity. The UE may receive, from the network node, the indication based at least in part on the network node assisted estimation. The indication may be associated with an RRC based indication, a DCI based indication, or a MAC-CE. The dynamic block interleaver selection may be based at least in part on a tap separation in a time domain corresponding to an estimated channel periodicity not exceeding an upper limit of a channel tap separation.

In some aspects, the indication of the dynamic block interleaver selection may be a periodic indication based at least in part on a periodic reference signal used to perform a channel periodicity estimation. The periodic indication may indicate a dynamic block interleaver switching or no dynamic block interleaver switching at a fixed interval. In some aspects, the indication of the dynamic block interleaver selection may be an aperiodic indication based at least in part on an aperiodic reference signal used to perform a channel periodicity estimation. The aperiodic indication may indicate a dynamic block interleaver switching or no dynamic block interleaver switching after the channel periodicity estimation is performed.

In some aspects, with dynamic interleaver switching, the network node may adopt a dynamic block interleaver selection from among the finite set of candidate interleaver configurations for the VRB-to-PRB mapping in the frequency domain. The network node may be aware of an underlying periodicity of a channel. A set of candidate block interleavers may be defined as B={B1, B2, . . . , Bk} with a corresponding interleaver span in a tap domain as T={T1, T2, . . . , Tk}. A separation between taps in an underlying channel may be defined as T_{ch}. An interleaver selection criterion may be defined based at least in part on T_{ch}. The network node may select a block interleaver configuration having an interleaver span that is furthest away from a channel periodicity. In other words, the interleaver selection criterion to pick a block interleaver Ti* may be in accordance with:

$${i}^{*} ( T , {T}_{max} ) = {arg max}_{i = 1 , 2 , … , k} {\sum }_{j = 1}^{{T}_{max / Ti}} {\vert {T}_{c h} - jTi \vert}^{2} ,$$

where Tₘₐₓ is an upper limit of a channel tap separation that is permissible, Tₘₐₓ defines a range of tap domain delay spreads over which such an optimization is performed, and Tₘₐₓ is a hardcoded value in a specification or an RRC configured value based at least in part on a channel history.

In some aspects, regarding a choice of candidate block interleavers, in order for candidate block interleavers to span disjoint sets of tap separation, a number of columns may have a non-overlapping set of common multiples within a range (0, Tₘₐₓ). In some aspects, a set of block interleavers may be configured in a manner such that a least common multiple (LCM) of a corresponding set of interleaver spans is greater than Tₘₐₓ. In other words, T={T1, T2, . . . , Tk} may be selected such that LCM (T)>Tₘₐₓ, which may imply that for each value t in (0, Tₘₐₓ), there exists at least one block interleaver whose interleaver span does not divide t.

In some aspects, Tₘₐₓ may be configured based at least in part on a network topology (e.g., a cellular ISD) and/or a frequency band of operation. Macro cells with a lower frequency range may experience a larger delay spread range and hence opt for a larger Tₘₐₓ. Micro cells with a higher frequency range and/or massive MIMO beamforming may select a smaller Tₘₐₓ.

In some aspects, regarding a dynamic block interleaver selection, a channel periodicity or a T_{ch} detection may involve a determination of the number of dominant taps in the underlying channel and/or an estimation of a tap separation in a channel impulse response (CIR) domain. While the estimation of the tap separation in the CIR domain may be achieved by a legacy delay spread estimation framework in a receiver, the determination of the number of the dominant taps in the underlying channel may involve additional processing that determines a feasibility of such detection/estimation at the UE or the network node based at least in part on an available processing power. A switching indication may be communicated over the air for the dynamic block interleaver selection.

In some aspects, a dynamic block interleaver switching may depend on the channel periodicity, which may be estimated at the UE or at the network node (e.g., transmitter or receiver) based at least in part on uplink or downlink reference signals. In some aspects, an estimation of the channel periodicity may be UE assisted, where the estimation may be based at least in part on one or more SSBs. In some aspects, an estimation of the channel periodicity may be UE assisted, where the estimation may be based at least in part on one or more CSI-RSs and/or one or more TRSs. In this case, the UE (receiver) may indicate channel characteristics to the network node via a dedicated CSI report. A CSI-RS based estimation may be preferred over an SSB based estimation because the SSB may be narrowband, whereas the CSI-RS may be wideband. In some aspects, an estimation of the channel periodicity may be UE assisted, where the estimation may be based at least in part on a DMRS. In some aspects, an estimation of the channel periodicity may be network node assisted, where the estimation may be based at least in part on an uplink SRS and an assumed channel reciprocity. A network node based estimation of the channel periodicity may be restricted to a time division duplexing (TDD) deployment and may be applicable to cell-center UEs with limited scattering and interference. The network node based estimation of the channel periodicity may be helpful when a CSI report lacks a frequency domain resolution or incurs a heavy overhead.

In some aspects, the network node and/or the UE may implement a dynamic block interleaver switching when a channel periodicity is within Tₘₐₓ. The network node may implement the dynamic block interleaver switching when an estimated periodicity of the channel corresponds to a tap separation that does not exceed a maximum allowed tap separation in a time domain, which may be given by Tₘₐₓ. A too-frequent block interleaver switching may require a large signaling overhead, so to avoid the large overhead, the network node may include a certain degree of hysteresis in a block interleaver switching mechanism.

In some aspects, a dynamic block interleaver switching may include a margin of ∂ in accordance with:

$${\sum }_{j = 1}^{{T}_{max / {Ti}_{{\vert {T}_{ch} - {jTi}^{*} \vert}^{2}}^{*}}} {\vert {T}_{c h} - j T {i}^{*} \vert}^{2} > {\sum }_{j = 1}^{{T}_{max / {T}_{c u r r}}} {\vert {T}_{c h} - j {T}_{c u r r} \vert}^{2} + \partial ,$$

where T_{curr} is an interleaver span of a current block interleaver, and ∂ may depend on a set T and Tₘₐₓ. The network node may make a switch from T_{curr} to Ti* when such a condition is satisfied.

In some aspects, for the network node assisted estimation, the network node may inform the UE regarding an impending block interleaver switch. In a first option, the network node may transmit an RRC indication to the UE. The RRC indication May include an information element (IE), in addition to a vrb-ToPRB-Interleaver NR RRC IE, to indicate an index of a switched block interleaver i*. In a second option, the network node may transmit a DCI indication to the UE, where [log 2(k)] bits in the DCI may be used to indicate an index of a switched block interleaver i*. Unless a channel is rapidly changing in a frequency domain slot-by-slot, utilizing the DCI to indicate the impending block interleaver switch may be expected to incur a relatively large overhead, which may be avoided by utilizing the RRC indication. In a third option, the network node may transmit a MAC-CE to the UE, where the MAC-CE may indicate the impending block interleaver switch.

In some aspects, for the UE-assisted estimation, the UE may feedback a block interleaver selection to the network node, either in an explicit manner or in an implicit manner. With the explicit manner, the UE may inform the network node regarding a preferred block interleaver index i* in a CSI report. With the implicit manner, the UE may feedback an estimated delay bin, and the network node may use a preconfigured lookup table to map a UE-reported delay bin to a preferred block interleaver index i*.

In some aspects, an indication of a switched block interleaver may be periodic or aperiodic, depending on a reference signal based at least in part on which an estimation is performed. In a first option, for a periodic indication, the network node may indicate a block interleaver switch or no block interleaver switching at fixed intervals. The periodic indication by the network node may be based at least in part on a periodic SRS based network node estimation of a periodic channel. The periodic indication may be based at least in part on an RRC indication or a DCI indication, which may follow an SRS estimation. The periodic indication by the network node may be based at least in part on a periodic CSI-RS or DMRS based UE estimation of a periodic channel, in which a UCI based indication in a periodic CSI reporting may be utilized. In a second option, for an aperiodic indication, the network node may indicate a block interleaver switch or no block interleaver switching when a channel periodicity is detected and estimated. The aperiodic indication by the network node may be based at least in part on an SRS based network node estimation. The aperiodic indication may be based at least in part on an RRC indication or a DCI indication, which may follow an SRS estimation. The aperiodic indication by the network node may be based at least in part on a CSI-RS or TRS based UE estimation, in which a UCI based indication in a aperiodic CSI reporting may be utilized. The aperiodic indication by the UE may be based at least in part on an SSB based estimation, which may be used when a TRS is absent or not configured, or when a TRS based estimation is less favorable than the SSB based estimation. In some aspects, a semi-persistent indication by the network node or the UE node may be based at least in part on the periodic and/or the aperiodic indication.

As shown by reference number 404, the UE and the network node may perform a communication based at least in part on the dynamic block interleaver selection. The dynamic block interleaver selection may be from the finite set of candidate block interleavers for the VRB-to-PRB mapping in the frequency domain. The dynamic block interleaver selection may be based at least in part on multiple block interleavers having different interleaving depths. The communication may be via the periodic channel, which may exhibit some degree of periodicity in its frequency response. By employing the dynamic block interleaver selection, periodic throughput dips in the periodic channel may be avoided.

As indicated above, FIG. 4 is provided as an example. Other examples may differ from what is described with regard to FIG. 4.

FIG. 5 is a diagram illustrating an example process 500 performed, for example, at a UE or an apparatus of a UE. Example process 500 is an example where the apparatus or the UE (e.g., UE 120) performs operations associated with dynamic block interleaver selection.

As shown in FIG. 5, in some aspects, process 500 may include receiving an indication of a dynamic block interleaver selection from a finite set of candidate block interleavers for a VRB-to-PRB mapping in a frequency domain (block 510). For example, the UE (e.g., using reception component 702 or communication manager 706, depicted in FIG. 7) may receive an indication of a dynamic block interleaver selection from a finite set of candidate block interleavers for a VRB-to-PRB mapping in a frequency domain, as described above.

As further shown in FIG. 5, in some aspects, process 500 may include performing a communication based at least in part on the dynamic block interleaver selection (block 520). For example, the UE (e.g., using communication manager 706, depicted in FIG. 7) may perform a communication based at least in part on the dynamic block interleaver selection, as described above.

Process 500 may include additional aspects, such as any single aspect or any combination of aspects described below or in connection with one or more other processes described elsewhere herein.

In a first aspect, the dynamic block interleaver selection is based at least in part on a separation between taps in an underlying periodic channel, and the dynamic block interleaver selection is based at least in part on an upper limit of a channel tap separation that is permissible.

In a second aspect, alone or in combination with the first aspect, the upper limit of the channel tap separation defines a range of tap domain delay spreads over which a dynamic block interleaving is performed.

In a third aspect, alone or in combination with one or more of the first and second aspects, the upper limit of the channel tap separation is a predefined value or an RRC configured value based at least in part on a channel history.

In a fourth aspect, alone or in combination with one or more of the first through third aspects, the finite set of candidate block interleavers are configured such that a least common multiple of a corresponding set of interleaver spans is greater than the upper limit of the channel tap separation.

In a fifth aspect, alone or in combination with one or more of the first through fourth aspects, the upper limit of the channel tap separation is based at least in part on one or more of a cellular ISD or a frequency band of operation.

In a sixth aspect, alone or in combination with one or more of the first through fifth aspects, the dynamic block interleaver selection is based at least in part on an interleaver span of a current block interleaver and a margin, and the margin is based at least in part on the interleaver span of the finite set of candidate block interleavers and the upper limit of the channel tap separation.

In a seventh aspect, alone or in combination with one or more of the first through sixth aspects, the dynamic block interleaver selection is based at least in part on an estimated channel periodicity using a reference signal.

In an eighth aspect, alone or in combination with one or more of the first through seventh aspects, the estimated channel periodicity is based at least in part on a UE-assisted estimation using at least one of an SSB, a CSI-RS, a TRS, or a DMRS.

In a ninth aspect, alone or in combination with one or more of the first through eighth aspects, process 500 includes transmitting, based at least in part on the UE-assisted estimation, feedback that indicates a preferred dynamic block interleaver or an estimated delay bin, wherein the indication of the preferred dynamic block interleaver is based at least in part on the feedback.

In a tenth aspect, alone or in combination with one or more of the first through ninth aspects, the estimated channel periodicity is based at least in part on a network node assisted estimation, and the network node assisted estimation is based at least in part on an uplink SRS and a channel reciprocity.

In an eleventh aspect, alone or in combination with one or more of the first through tenth aspects, process 500 includes receiving the indication based at least in part on the network node assisted estimation, and the indication is associated with one of an RRC based indication, a DCI based indication, or a MAC-CE.

In a twelfth aspect, alone or in combination with one or more of the first through eleventh aspects, the dynamic block interleaver selection is based at least in part on a tap separation in a time domain corresponding to an estimated channel periodicity not exceeding an upper limit of a channel tap separation.

In a thirteenth aspect, alone or in combination with one or more of the first through twelfth aspects, the indication of the dynamic block interleaver selection is a periodic indication based at least in part on a periodic reference signal used to perform a channel periodicity estimation, and the periodic indication indicates a dynamic block interleaver switching or no dynamic block interleaver switching at a fixed interval.

In a fourteenth aspect, alone or in combination with one or more of the first through thirteenth aspects, the indication of the dynamic block interleaver selection is an aperiodic indication based at least in part on an aperiodic reference signal used to perform a channel periodicity estimation, and the aperiodic indication indicates a dynamic block interleaver switching or no dynamic block interleaver switching after the channel periodicity estimation is performed.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, at a network node or an apparatus of a network node. Example process 600 is an example where the apparatus or the network node (e.g., network node 110) performs operations associated with dynamic block interleaver selection.

As shown in FIG. 6, in some aspects, process 600 may include transmitting an indication of a dynamic block interleaver selection from a finite set of candidate block interleavers for a VRB-to-PRB mapping in a frequency domain (block 610). For example, the network node (e.g., using transmission component 804 or communication manager 806, depicted in FIG. 8) may transmit an indication of a dynamic block interleaver selection from a finite set of candidate block interleavers for a VRB-to-PRB mapping in a frequency domain, as described above.

As further shown in FIG. 6, in some aspects, process 600 may include performing a communication based at least in part on the dynamic block interleaver selection (block 620). For example, the network node (e.g., using communication manager 806, depicted in FIG. 8) may perform a communication based at least in part on the dynamic block interleaver selection, as described above.

Process 600 may include additional aspects, such as any single aspect or any combination of aspects described below or in connection with one or more other processes described elsewhere herein.

In a first aspect, the dynamic block interleaver selection is based at least in part on a separation between taps in an underlying periodic channel, and the dynamic block interleaver selection is based at least in part on an upper limit of a channel tap separation that is permissible.

In a second aspect, alone or in combination with the first aspect, the upper limit of the channel tap separation defines a range of tap domain delay spreads over which a dynamic block interleaving is performed.

In a third aspect, alone or in combination with one or more of the first and second aspects, the upper limit of the channel tap separation is a predefined value or an RRC configured value based at least in part on a channel history.

In a fourth aspect, alone or in combination with one or more of the first through third aspects, the finite set of candidate block interleavers are configured such that a least common multiple of a corresponding set of interleaver spans is greater than the upper limit of the channel tap separation.

In a fifth aspect, alone or in combination with one or more of the first through fourth aspects, the upper limit of the channel tap separation is based at least in part on one or more of a cellular ISD or a frequency band of operation.

In a sixth aspect, alone or in combination with one or more of the first through fifth aspects, the dynamic block interleaver selection is based at least in part on an interleaver span of a current block interleaver and a margin, and the margin is based at least in part on the interleaver span of the finite set of candidate block interleavers and the upper limit of the channel tap separation.

In a seventh aspect, alone or in combination with one or more of the first through sixth aspects, the dynamic block interleaver selection is based at least in part on an estimated channel periodicity using a reference signal.

In an eighth aspect, alone or in combination with one or more of the first through seventh aspects, the estimated channel periodicity is based at least in part on a UE-assisted estimation using at least one of an SSB, a CSI-RS, a TRS, or a DMRS.

In a ninth aspect, alone or in combination with one or more of the first through eighth aspects, process 600 includes receiving, based at least in part on the UE-assisted estimation, feedback that indicates a preferred dynamic block interleaver or an estimated delay bin, wherein the indication of the preferred dynamic block interleaver is based at least in part on the feedback.

In a tenth aspect, alone or in combination with one or more of the first through ninth aspects, the estimated channel periodicity is based at least in part on a network node assisted estimation, and the network node assisted estimation is based at least in part on an uplink SRS and a channel reciprocity.

In an eleventh aspect, alone or in combination with one or more of the first through tenth aspects, process 600 includes transmitting the indication based at least in part on the network node assisted estimation, and the indication is associated with one of an RRC based indication, a DCI based indication, or a MAC-CE.

In a twelfth aspect, alone or in combination with one or more of the first through eleventh aspects, the dynamic block interleaver selection is based at least in part on a tap separation in a time domain corresponding to an estimated channel periodicity not exceeding an upper limit of a channel tap separation.

In a thirteenth aspect, alone or in combination with one or more of the first through twelfth aspects, the indication of the dynamic block interleaver selection is a periodic indication based at least in part on a periodic reference signal used to perform a channel periodicity estimation, and the periodic indication indicates a dynamic block interleaver switching or no dynamic block interleaver switching at a fixed interval.

In a fourteenth aspect, alone or in combination with one or more of the first through thirteenth aspects, the indication of the dynamic block interleaver selection is an aperiodic indication based at least in part on an aperiodic reference signal used to perform a channel periodicity estimation, and the aperiodic indication indicates a dynamic block interleaver switching or no dynamic block interleaver switching after the channel periodicity estimation is performed.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a UE, or a UE may include the apparatus 700. In some aspects, the apparatus 700 includes a reception component 702, a transmission component 704, or a communication manager 706, which may be in communication with one another (for example, via one or more buses or one or more other components). In some aspects, the communication manager 706 is the communication manager 150 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (for example, the processing system 140 described in connection with FIG. 1) of the UE.

In some aspects, the apparatus 700 may be configured to perform one or more operations described herein in connection with FIG. 4. Additionally, or alternatively, the apparatus 700 may be configured to perform one or more processes described herein, such as process 500 of FIG. 5. In some aspects, the apparatus 700 or one or more components shown in FIG. 7 may include one or more components of the UE described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the UE described above in connection with FIG. 1, such as a radio, one or more RF chains, one or more transceivers, or one or more modems, each of which may in turn be coupled with one or more antennas of the UE.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 704 may be co-located with the reception component 702.

The communication manager 706 may support operations of the reception component 702 or the transmission component 704. For example, the communication manager 706 may receive information associated with configuring reception of communications by the reception component 702 or transmission of communications by the transmission component 704. Additionally, or alternatively, the communication manager 706 may generate or provide control information to the reception component 702 or the transmission component 704 to control reception or transmission of communications.

The reception component 702 may receive an indication of a dynamic block interleaver selection from a finite set of candidate block interleavers for a VRB-to-PRB mapping in a frequency domain. The communication manager 706 may perform a communication based at least in part on the dynamic block interleaver selection.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication. The apparatus 800 may be a network node, or a network node may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 155 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 145 described in connection with FIG. 1) of the network node.

In some aspects, the apparatus 800 may be configured to perform one or more operations described herein in connection with FIG. 4. Additionally, or alternatively, the apparatus 800 may be configured to perform one or more processes described herein, such as process 600 of FIG. 6. In some aspects, the apparatus 800 or one or more components shown in FIG. 8 may include one or more components of the network node described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the network node described above in connection with FIG. 1, such as a radio, one or more RF chains, one or more transceivers, or one or more modems, each of which may in turn be coupled with one or more antennas of the network node. In some aspects, the reception component 802 or the transmission component 804 may include or may be included in a network interface. The network interface may be configured to obtain or output signals for the apparatus 800 via one or more communications links, such as a backhaul link, a midhaul link, or a fronthaul link.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The transmission component 804 may transmit an indication of a dynamic block interleaver selection from a finite set of candidate block interleavers for a VRB-to-PRB mapping in a frequency domain. The communication manager 806 May perform a communication based at least in part on the dynamic block interleaver selection.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:
Aspect 1: A method of wireless communication performed by a user equipment (UE), comprising: receiving an indication of a dynamic block interleaver selection from a finite set of candidate block interleavers for a virtual resource block to physical resource block mapping in a frequency domain; and performing a communication based at least in part on the dynamic block interleaver selection.
Aspect 2: The method of Aspect 1, wherein the dynamic block interleaver selection is based at least in part on a separation between taps in an underlying periodic channel, and wherein the dynamic block interleaver selection is based at least in part on an upper limit of a channel tap separation that is permissible.
Aspect 3: The method of Aspect 2, wherein the upper limit of the channel tap separation defines a range of tap domain delay spreads over which a dynamic block interleaving is performed.
Aspect 4: The method of Aspect 2, wherein the upper limit of the channel tap separation is a predefined value or a radio resource control configured value based at least in part on a channel history.
Aspect 5: The method of Aspect 2, wherein the finite set of candidate block interleavers are configured such that a least common multiple of a corresponding set of interleaver spans is greater than the upper limit of the channel tap separation.
Aspect 6: The method of Aspect 2, wherein the upper limit of the channel tap separation is based at least in part on one or more of: a cellular inter-site distance or a frequency band of operation.
Aspect 7: The method of Aspect 2, wherein the dynamic block interleaver selection is based at least in part on an interleaver span of a current block interleaver and a margin, and wherein the margin is based at least in part on the interleaver span of the finite set of candidate block interleavers and the upper limit of the channel tap separation.
Aspect 8: The method of any of Aspects 1-7, wherein the dynamic block interleaver selection is based at least in part on an estimated channel periodicity using a reference signal.
Aspect 9: The method of Aspect 8, wherein the estimated channel periodicity is based at least in part on a UE-assisted estimation using at least one of: a synchronization signal block, a channel state information reference signal, a tracking reference signal, or a demodulation reference signal.
Aspect 10: The method of Aspect 9, further comprising: transmitting, based at least in part on the UE-assisted estimation, feedback that indicates a preferred dynamic block interleaver or an estimated delay bin, wherein the indication of the preferred dynamic block interleaver is based at least in part on the feedback.
Aspect 11: The method of Aspect 8, wherein the estimated channel periodicity is based at least in part on a network node assisted estimation, and wherein the network node assisted estimation is based at least in part on an uplink sounding reference signal and a channel reciprocity.
Aspect 12: The method of Aspect 11, wherein receiving the indication is based at least in part on the network node assisted estimation, and wherein the indication is associated with one of: a radio resource control based indication, a downlink control information based indication, or a medium access control control element.
Aspect 13: The method of any of Aspects 1-12, wherein the dynamic block interleaver selection is based at least in part on a tap separation in a time domain corresponding to an estimated channel periodicity not exceeding an upper limit of a channel tap separation.
Aspect 14: The method of any of Aspects 1-13, wherein the indication of the dynamic block interleaver selection is a periodic indication based at least in part on a periodic reference signal used to perform a channel periodicity estimation, and wherein the periodic indication indicates a dynamic block interleaver switching or no dynamic block interleaver switching at a fixed interval.
Aspect 15: The method of any of Aspects 1-14, wherein the indication of the dynamic block interleaver selection is an aperiodic indication based at least in part on an aperiodic reference signal used to perform a channel periodicity estimation, and wherein the aperiodic indication indicates a dynamic block interleaver switching or no dynamic block interleaver switching after the channel periodicity estimation is performed.
Aspect 16: A method of wireless communication performed by a network node, comprising: transmitting an indication of a dynamic block interleaver selection from a finite set of candidate block interleavers for a virtual resource block to physical resource block mapping in a frequency domain; and performing a communication based at least in part on the dynamic block interleaver selection.
Aspect 17: The method of Aspect 16, wherein the dynamic block interleaver selection is based at least in part on a separation between taps in an underlying periodic channel, and wherein the dynamic block interleaver selection is based at least in part on an upper limit of a channel tap separation that is permissible.
Aspect 18: The method of Aspect 17, wherein the upper limit of the channel tap separation defines a range of tap domain delay spreads over which a dynamic block interleaving is performed.
Aspect 19: The method of Aspect 17, wherein the upper limit of the channel tap separation is a predefined value or a radio resource control configured value based at least in part on a channel history.
Aspect 20: The method of Aspect 17, wherein the finite set of candidate block interleavers are configured such that a least common multiple of a corresponding set of interleaver spans is greater than the upper limit of the channel tap separation.
Aspect 21: The method of Aspect 17, wherein the upper limit of the channel tap separation is based at least in part on one or more of: a cellular inter-site distance or a frequency band of operation.
Aspect 22: The method of Aspect 17, wherein the dynamic block interleaver selection is based at least in part on an interleaver span of a current block interleaver and a margin, and wherein the margin is based at least in part on the interleaver span of the finite set of candidate block interleavers and the upper limit of the channel tap separation.
Aspect 23: The method of any of Aspects 16-22, wherein the dynamic block interleaver selection is based at least in part on an estimated channel periodicity using a reference signal.
Aspect 24: The method of Aspect 23, wherein the estimated channel periodicity is based at least in part on a user equipment (UE)-assisted estimation using at least one of: a synchronization signal block, a channel state information reference signal, a tracking reference signal, or a demodulation reference signal.
Aspect 25: The method of Aspect 24, further comprising: receiving, based at least in part on the UE-assisted estimation, feedback that indicates a preferred dynamic block interleaver or an estimated delay bin, wherein the indication of the preferred dynamic block interleaver is based at least in part on the feedback.
Aspect 26: The method of Aspect 23, wherein the estimated channel periodicity is based at least in part on a network node assisted estimation, and wherein the network node assisted estimation is based at least in part on an uplink sounding reference signal and a channel reciprocity.
Aspect 27: The method of Aspect 26, wherein transmitting the indication is based at least in part on the network node assisted estimation, and wherein the indication is associated with one of: a radio resource control based indication, a downlink control information based indication, or a medium access control control element.
Aspect 28: The method of any of Aspects 16-27, wherein the dynamic block interleaver selection is based at least in part on a tap separation in a time domain corresponding to an estimated channel periodicity not exceeding an upper limit of a channel tap separation.
Aspect 29: The method of any of Aspects 16-28, wherein the indication of the dynamic block interleaver selection is a periodic indication based at least in part on a periodic reference signal used to perform a channel periodicity estimation, and wherein the periodic indication indicates a dynamic block interleaver switching or no dynamic block interleaver switching at a fixed interval.
Aspect 30: The method of any of Aspects 16-29, wherein the indication of the dynamic block interleaver selection is an aperiodic indication based at least in part on an aperiodic reference signal used to perform a channel periodicity estimation, and wherein the aperiodic indication indicates a dynamic block interleaver switching or no dynamic block interleaver switching after the channel periodicity estimation is performed.
Aspect 31: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-30.
Aspect 32: An apparatus for wireless communication at a device, the apparatus comprising one or more memories and one or more processors coupled to the one or more memories, the one or more processors configured to cause the device to perform the method of one or more of Aspects 1-30.
Aspect 33: An apparatus for wireless communication, the apparatus comprising at least one means for performing the method of one or more of Aspects 1-30.
Aspect 34: A non-transitory computer-readable medium storing code for wireless communication, the code comprising instructions executable by one or more processors to perform the method of one or more of Aspects 1-30.
Aspect 35: A non-transitory computer-readable medium storing a set of instructions for wireless communication, the set of instructions comprising one or more instructions that, when executed by one or more processors of a device, cause the device to perform the method of one or more of Aspects 1-30.
Aspect 36: A device for wireless communication, the device comprising a processing system that includes one or more processors and one or more memories coupled with the one or more processors, the processing system configured to cause the device to perform the method of one or more of Aspects 1-30.
Aspect 37: An apparatus for wireless communication at a device, the apparatus comprising one or more memories and one or more processors coupled to the one or more memories, the one or more processors individually or collectively configured to cause the device to perform the method of one or more of Aspects 1-30.
Aspect 38: A device comprising a processing system that includes one or more processors and one or more code-storing memories coupled with the one or more processors, the processing system configured to cause the device to perform the method of one or more of Aspects 1-30.
Aspect 39: A device comprising a processing system that includes processor circuitry and code-storing memory circuitry, the processing system configured to cause the device to perform the method of one or more of Aspects 1-30.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
receive an indication of a dynamic block interleaver selection from a finite set of candidate block interleavers for a virtual resource block to physical resource block mapping in a frequency domain; and
perform a communication based at least in part on the dynamic block interleaver selection.

2. The apparatus of claim 1, wherein the dynamic block interleaver selection is based at least in part on a separation between taps in an underlying periodic channel, and wherein the dynamic block interleaver selection is based at least in part on an upper limit of a channel tap separation that is permissible.

3. The apparatus of claim 2, wherein the upper limit of the channel tap separation defines a range of tap domain delay spreads over which a dynamic block interleaving is performed.

4. The apparatus of claim 2, wherein the upper limit of the channel tap separation is a predefined value or a radio resource control configured value based at least in part on a channel history.

5. The apparatus of claim 2, wherein the finite set of candidate block interleavers are configured such that a least common multiple of a corresponding set of interleaver spans is greater than the upper limit of the channel tap separation.

6. The apparatus of claim 2, wherein the upper limit of the channel tap separation is based at least in part on one or more of: a cellular inter-site distance or a frequency band of operation.

7. The apparatus of claim 2, wherein the dynamic block interleaver selection is based at least in part on an interleaver span of a current block interleaver and a margin, and wherein the margin is based at least in part on the interleaver span of the finite set of candidate block interleavers r and the upper limit of the channel tap separation.

8. The apparatus of claim 1, wherein the dynamic block interleaver selection is based at least in part on an estimated channel periodicity using a reference signal.

9. The apparatus of claim 8, wherein the estimated channel periodicity is based at least in part on a UE-assisted estimation using at least one of: a synchronization signal block, a channel state information reference signal, a tracking reference signal, or a demodulation reference signal.

10. The apparatus of claim 9, wherein the one or more processors are further configured to cause the UE to:
transmit, based at least in part on the UE-assisted estimation, feedback that indicates a preferred dynamic block interleaver or an estimated delay bin, wherein the indication of the preferred dynamic block interleaver is based at least in part on the feedback.

11. The apparatus of claim 8, wherein the estimated channel periodicity is based at least in part on a network node assisted estimation, and wherein the network node assisted estimation is based at least in part on an uplink sounding reference signal and a channel reciprocity.

12. The apparatus of claim 11, wherein the one or more processors are further configured to cause the UE to:
receive the indication based at least in part on the network node assisted estimation, and wherein the indication is associated with one of: a radio resource control based indication, a downlink control information based indication, or a medium access control control element.

13. The apparatus of claim 1, wherein the dynamic block interleaver selection is based at least in part on a tap separation in a time domain corresponding to an estimated channel periodicity not exceeding an upper limit of a channel tap separation.

14. The apparatus of claim 1, wherein the indication of the dynamic block interleaver selection is a periodic indication based at least in part on a periodic reference signal used to perform a channel periodicity estimation, and wherein the periodic indication indicates a dynamic block interleaver switching or no dynamic block interleaver switching at a fixed interval.

15. The apparatus of claim 1, wherein the indication of the dynamic block interleaver selection is an aperiodic indication based at least in part on an aperiodic reference signal used to perform a channel periodicity estimation, and wherein the aperiodic indication indicates a dynamic block interleaver switching or no dynamic block interleaver switching after the channel periodicity estimation is performed.

16. An apparatus for wireless communication at a network node, comprising:
one or more memories; and
one or more processors, coupled to the one or more memories, configured to cause the network node to:
transmit an indication of a dynamic block interleaver selection from a finite set of candidate block interleavers for a virtual resource block to physical resource block mapping in a frequency domain; and
perform a communication based at least in part on the dynamic block interleaver selection.

17. The apparatus of claim 16, wherein the dynamic block interleaver selection is based at least in part on a separation between taps in an underlying periodic channel, wherein the dynamic block interleaver selection is based at least in part on an upper limit of a channel tap separation that is permissible, and wherein the upper limit of the channel tap separation defines a range of tap domain delay spreads over which a dynamic block interleaving is performed.

18. The apparatus of claim 16, wherein the dynamic block interleaver selection is based at least in part on an estimated channel periodicity using a reference signal.

19. The apparatus of claim 16, wherein:
the indication of the dynamic block interleaver selection is a periodic indication based at least in part on a periodic reference signal used to perform a channel periodicity estimation, and the periodic indication indicates a dynamic block interleaver switching or no dynamic block interleaver switching at a fixed interval; or
the indication of the dynamic block interleaver selection is an aperiodic indication based at least in part on an aperiodic reference signal used to perform a channel periodicity estimation, and wherein the aperiodic indication indicates a dynamic block interleaver switching or no dynamic block interleaver switching after the channel periodicity estimation is performed.

20. A method of wireless communication performed by a user equipment (UE), comprising:
receiving an indication of a dynamic block interleaver selection from a finite set of candidate block interleavers for a virtual resource block to physical resource block mapping in a frequency domain; and
performing a communication based at least in part on the dynamic block interleaver selection.
